(19) United States
(12) Patent Application Publication
(10) Pub. No.: US 2005/0047423 A1
(43) Pub. Date: Mar. 3, 2005

(54) Protocol interworking framework

(76) Inventors: Bharat B. Kaul, Los Angeles, CA (US); Narendra C. Tulpule, Carlsbad, CA (US); Dikshit Sawhney, Los Angeles, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/651,531

(22) Filed: Aug. 29, 2003

(51) Int. Cl. H04L 12/28

(52) U.S. Cl. 370/401

(57) ABSTRACT

A method and apparatus to perform an interworking function for a network.

### BACKGROUND

A Voice Over Packet (VOP) system may communicate telephone calls over a packet network. The VOP system may establish a telephone call between two or more call terminals using a number of different communication protocols. Some VOP systems, however, may have some difficulty in completing a telephone call between call terminals configured to use different protocols. Consequently, there may be need for improvements in such VOP systems.

### BRIEF DESCRIPTION OF THE DRAWINGS

The subject matter regarded as the embodiments is particularly pointed out and distinctly claimed in the concluding portion of the specification. The embodiments, however, both as to organization and method of operation, together with objects, features, and advantages thereof, may best be understood by reference to the following detailed description when read with the accompanying drawings in which:

FIG. 1 illustrates a first system suitable for practicing one embodiment;

FIG. 2 illustrates a block diagram of a processing system in accordance with one embodiment;

FIG. 3 is a block flow diagram of the programming logic performed by an Interworking Function Module (IFW) node in accordance with one embodiment;

FIGS. 4A and 4B illustrate a first set of call flow diagrams for one embodiment;

FIGS. 5A-C illustrate a second set of call flow diagrams for one embodiment; and

FIG. 6 illustrates a second system suitable for practicing one embodiment;

### DETAILED DESCRIPTION

Numerous specific details may be set forth herein to provide a thorough understanding of the embodiments of the invention. It will be understood by those skilled in the art, however, that the embodiments of the invention may be practiced without these specific details. In other instances, well-known methods, procedures, components and circuits have not been described in detail so as not to obscure the embodiments of the invention. It can be appreciated that the specific structural and functional details disclosed herein may be representative and do not necessarily limit the scope of the invention.

It is worthy to note that any reference in the specification to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

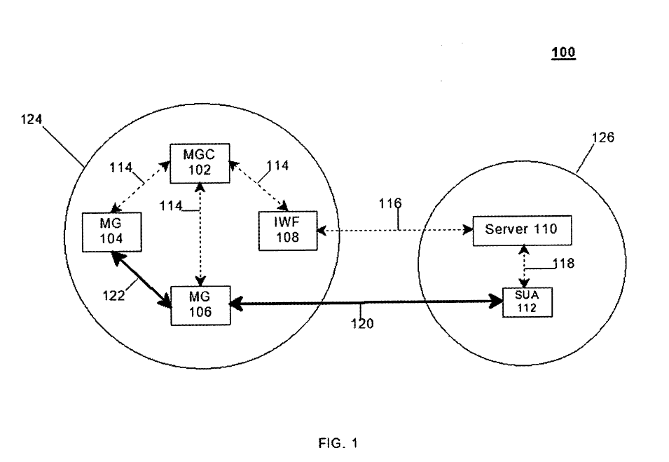

Referring now in detail to the drawings wherein like parts are designated by like reference numerals throughout, there is illustrated in FIG. 1 a system suitable for practicing one embodiment. FIG. 1 is a block diagram of a system 100. In one embodiment, system 100 may represent a VOP system. VOP system 100 may comprise a packet-based multimedia communication system. VOP system 100 may communicate Internet multimedia conferences and telephone calls, for example.

In one embodiment, VOP system 100 may comprise a plurality of network nodes. The term “network node” as used herein may refer to any node capable of communicating information in accordance with one or more protocols. Examples of network nodes may include a computer, server, switch, router, bridge, gateway, personal digital assistant, mobile device, call terminal and so forth. The term “protocol” as used herein may refer to a set of instructions to control how the information is communicated over the communications medium.

In one embodiment, VOP system 100 may communicate various types of information between the various network nodes. For example, one type of information may comprise “media information.” Media information may refer to any data representing content meant for a user. Examples of content may include, for example, data from a voice conversation, audio conference, video conference, streaming video, electronic mail (“email”) message, voice mail message, alphanumeric symbols, graphics, image, video, text and so forth. In one embodiment, the media information may comprise data from a voice conversation during a telephone call, for example. Data from a voice conversation may be, for example, speech information, silence periods, background noise, comfort noise, tones and so forth. Another type of information may comprise “signaling information.” Signaling information may refer to any data representing signals, commands, instructions or control words meant for an automated system. For example, signaling information may be used to setup and manage a telephone call through a network, or instruct a network node to process the media information in a predetermined manner.

In one embodiment, one or more communications mediums may connect the nodes. The term “communications medium” as used herein may refer to any medium capable of carrying information signals. Examples of communications mediums may include metal leads, semiconductor material, twisted-pair wire, co-axial cable, fiber optic, radio frequencies (RF) and so forth. The terms “connection” or “interconnection,” and variations thereof, in this context may refer to physical connections and/or logical connections.

In one embodiment, the network nodes may communicate the media and signaling information to each other in the form of packets. A packet in this context may refer to a set of information of a limited length, with the length typically represented in terms of bits or bytes. An example of a packet length might be 1000 bytes.

In one embodiment, the packets may be communicated in accordance with one or more packet protocols. For example, in one embodiment the packet protocols may include one or more Internet protocols, such as the Transmission Control Protocol (TCP), Internet Protocol (IP), and so forth. The embodiments are not limited in this context.

In one embodiment, VOP system 100 may utilize one or more VOP protocols for a multimedia session to convey media information. Examples of a multimedia session may comprise a VOP telephone call, an audio conference call, a video conferencing call, and so forth. VOP system 100 may utilize one or more call management protocols to assist in the setup and control of a multimedia session. One aspect of setting up a multimedia session is to establish a signaling path to convey signaling information. The signaling path may be used to establish a media path between the two endpoints. The media path may be used to communicate the actual media information. The term “path” as used herein may refer to one or more physical communications mediums and network nodes used to convey the information between two endpoints, as well as any logical channels carried by the physical communications mediums.

In one embodiment, VOP system 100 may utilize several different call management protocols. For example, VOP system 100 may operate in accordance with the Internet Engineering Task Force (IETF) document titled “SIP: Session Initiation Protocol,” Proposed Standard, RFC 3261, June 2002 (“SIP Specification); the IETF document titled “SDP: Session Description Protocol,” Proposed Standard, RFC 2327, April 1998 (“SDP Specification”); and the IETF document titled “Megaco Protocol Version 1.0,” Proposed Standard, RFC 3015, November 2000 (“Megaco Specification”). The embodiments are not limited in this context.

Once a media path has been established, VOP system 100 may utilize a media transport protocol to communicate the media information over the media path. For example, VOP system 100 may communicate media information in accordance with the IETF document titled “RTP: A Transport Protocol For Real Time Applications,” Proposed Standard, RFC 1889, January 1996 (“RTP Specification”), for example. The embodiments are not limited in this context.

Referring again to FIG. 1, VOP system 100 may comprise networks 124 and 126. Networks 124 and 126 may comprise a plurality of network nodes connected by various communications mediums as shown. Although FIG. 1 shows a limited number of network nodes for clarity, it can be appreciated that any number of network nodes may be used in system 100.

In one embodiment, network 124 may comprise a plurality of network nodes configured to communicate information in accordance with the Megaco Specification (“Megaco Network”). For example, network 124 may comprise a Media Gateway Controller (MGC) 102, Media Gateway (MG) 104, MG 106, and an Interworking Function Node (IWF) 108. MGC 102 may communicate signaling information with MG 104, MG 106 and IWF 108 via signaling paths 114. Further, MG 104 and MG 106 may communicate media information directly to each other over media path 122 using a media transport protocol such as RTP, for example.

In one embodiment, MGC 102 may use Megaco to communicate with network nodes within the Megaco Network, such as MG 104, MG 106 and IWF 108. Megaco is a type of master-slave protocol. MGC 102 acts as the master and has complete call control intelligence. For example, MGC 102 may perform call processing functions such as address translation, admission control, call control signaling, call authorization, call management and so forth. MGC 102 instructs MG 104, MG 106 and IWF 108 to carry out its commands via signaling information communicated over signaling paths 114, for example. The signaling information enables the various network nodes to establish a media path to communicate the media information for a multimedia session.

In one embodiment, MGC 102 may further comprise a MGSIP module. IWF 108 may also comprise a similar MGSIP module, as discussed further below. The MGSIP module may be a thin client software module that is configured to extend the Megaco protocol as per the extension rules defined by the Megaco Specification for adding a package to the protocol. The MGSIP module may provide a set of events and signals to ease communication between the Megaco and SIP networks via the IWF node. The MGSIP module may, for example, enable MGC 102 to facilitate the establishment of a multimedia connection between nodes inside the Megaco network with nodes outside the Megaco network. The outside nodes may either be SIP call terminals or MGs in other Megaco Networks, for example. IWF 108 node may function to relay signaling information, with the help of events/signals defined in MGSIP package, between Megaco Network 124 and the outside world.

In one embodiment, MG 104 and MG 106 may represent the media handling elements of network 124. The term “media handling elements” may refer to those elements that actually process the media information, either as originated or received. For example, MG 104 and MG 106 may comprise call terminals having protocol stacks configured to operate in accordance with Megaco. The call terminals may comprise any device capable of communicating multimedia information, such as a telephone, a packet telephone, a mobile or cellular telephone, a processing system equipped with a modem or Network Interface Card (NIC), and so forth. In one embodiment, the call terminals may have a microphone to receive analog voice signals from a user, and a speaker to reproduce analog voice signals as per RTP packets received from another call terminal.

In one embodiment, network 126 may comprise a plurality of network nodes configured to communicate information in accordance with the SIP Specification (“SIP Network”). For example, network 126 may comprise a SIP server 110 and a SIP User Agent (SUA) 112. SIP server 110 may perform similar call processing functions for network 126 as MGC 102 performs for network 124. Further, SIP server 110 may also function as a SIP proxy or SIP registrar to assist in routing SIP packets to the appropriate endpoint. SIP server 110 may communicate with IWF 108 and SUA 112 via signaling information communicated over signaling paths 116 and 118, respectively, to perform these operations. Alternatively, it may be appreciated that SIP endpoints such as SUA 112 may also be capable of performing some or all of the functions of SIP server 110 in addition to handling the actual media information, according to a given implementation.

In one embodiment, SUA 112 may represent the media handling element for network 126. SUA 112 may be a call terminal having a protocol stack configured to operate in accordance with the SIP Specification and SDP Specification, for example. The call terminal may be any of the call terminals previously described. The embodiments are not limited in this context.

It may be appreciated that both networks 124 and 126 may have additional elements to assist in completing a multimedia session. For example, both networks may have conference servers, application servers, network address translators (NAT) or other dedicated devices to perform certain tasks. SIP Network 126 may also include additional SIP proxy servers and SIP registrars as well. The embodiments are not limited in this context.

In one embodiment, network 124 and network 126 may communicate with one another via signaling path 116 and media path 120, for example. Signaling path 116 may be used to communicate signaling information between networks 124 and 126. Media path 120 may be used to communicate media information between networks 124 and 126. Although only two paths are described for purposes of clarity, it may be appreciated that any number of connections may be used between networks 124 and 126, and still fall within the scope of the embodiments.

In one embodiment, signaling path 116 and media path 120 may be formed using one or more physical communications mediums as previously described. For example, the communications mediums may comprise RF spectrum for a wireless network, such as a cellular or mobile system. In this case, networks 124 and 126 may further comprise the devices and interfaces to convert the packet signals carried from a wired communications medium to RF signals. Examples of such devices and interfaces may include omni-directional antennas and wireless RF transceivers. The embodiments are not limited in this context.

In general operation of VOP system 100, assume a caller desires to initiate a multimedia call between MG 106 and SUA 112. A problem may occur, however, since MG 106 is configured to use signaling information generated in accordance with the Megaco Specification, and SUA 112 is configured to use signaling information generated in accordance with the SIP Specification. MGC 102 may not recognize the signaling information from SIP server 110, and vice-versa, thus preventing a multimedia session between the two call terminals. Consequently, the signaling information from MGC 102 should be translated to signaling information for SIP server 110, and vice-versa, to complete a multimedia session between a MG from network 124 and a SUA from network 126. Accordingly, IWF 108 may allow a multimedia session to be established between call terminals using different call management protocols, such as MG 106 and SUA 112, for example.

In one embodiment, IWF 108 may comprise a network node configured to operate as both a MG and SUA for purposes of communicating signaling information. The signaling information may be used to perform a variety of call management functions, such as call setup, call teardown, call transfer, call conferencing, call forwarding, call hold, and so forth. The types of call management functions are not limited in this context.

In one embodiment, IWF 108 may comprise, for example, an MG module, a SUA module and a Protocol Translation (PT) module. The SUA module may be used to communicate with another SIP entity, such as SIP server 110. The MG module may be used to communicate with another Megaco entity, such as MGC 102. The MG module may further comprise an MGSIP module similar to the one discussed previously with reference to MGC 102. The MGSIP module for IWF 108, however, may include added functionality, such as communicating event triggers between the MGSIP module and the IWF logic. The PT module may be used to perform translation of the signaling information and facilitate communication between the MG and SUA modules of IWF 108. This functionality may allow communication between network 124 and network 126 to set up a call connection, for example.

In general operation, IWF 108 may function as a protocol conversion interface between two different protocols, such as SIP and Megaco, for example. In one embodiment IWF 108 is designed to be a software based signaling element. It may be appreciated, however, that IWF 108 may be implemented as software, hardware, or a combination of both, and still fall within the scope of the embodiments. In one embodiment, IWF 108 does not necessarily handle any media traffic as compared to a conventional MG or SIP endpoint.

The presence of both a MG module and SUA module makes IWF 108 appear as a MG with respect to MGC 102, and a SUA with respect to SIP server 110. For example, IWF 108 is configured to perform all necessary functions to appear as a MG to MGC 102, and a SUA to SIP server 110. SIP server 110 may communicate SIP signaling information to the SUA module of IWF 108 via signaling path 116. MGC 102 may communicate Megaco signaling information to the MG module of IWF 108 via signaling path 114. The PT module for IWF 108 may receive the signaling information from one network and translate it to signaling information appropriate for the other network. In this manner, a seamless signaling path may be established between MGC 102 and SIP server 110. Once the signaling phase of setting up the multimedia session has been performed using the signaling path, SUA 112 and MG 106 may establish media path 120 between each other, and begin communicating media information. The address information to establish media path 120 is exchanged between the call terminals via the signaling messages. The media information may be communicated using any appropriate media processing protocol, such as RTP, for example. As mentioned previously, it can be appreciated that media path 120 is not necessarily the same path established for signaling path 116.

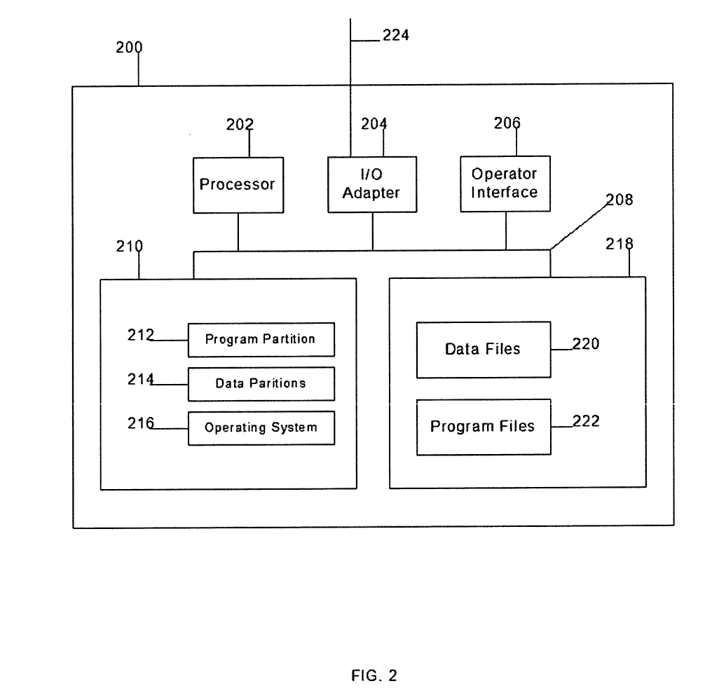

FIG. 2 illustrates a processing system in accordance with one embodiment. FIG. 2 illustrates a processing system 200. Processing system 200 may be used to implement functionality for the various embodiments as software executed by a processor. For example, processing system 200 may be used to implement an IWF node, such as IWF 108, and its various modules. It may be appreciated, however, that the embodiments may be implemented using hardware circuits or structures, or a combination of hardware and software, as desired for a particular implementation. The embodiments are not limited in this context.

As shown in FIG. 2, system 200 includes a processor 202, an input/output (I/O) adapter 204, an operator interface 206, a memory 210 and a disk storage 218. Memory 210 may store computer program instructions and data. The term “program instructions” may include computer code segments comprising words, values and symbols from a predefined computer language that, when placed in combination according to a predefined manner or syntax, cause a processor to perform a certain function. Examples of a computer language may include C, C++, JAVA, assembly and so forth. Processor 202 executes the program instructions, and processes the data, stored in memory 210. Disk storage 218 stores data to be transferred to and from memory 210. I/O adapter 204 communicates with other devices and transfers data in and out of the computer system over connection 224. Operator interface 206 may interface with a system operator by accepting commands and providing status information. All these elements are interconnected by bus 208, which allows data to be intercommunicated between the elements. I/O adapter 204 represents one or more I/O adapters or network interfaces that can connect to local or wide area networks such as, for example, the system described in FIG. 1. Therefore, connection 224 represents a network or a direct connection to other equipment.

Processor 202 can be any type of processor capable of providing the speed and functionality required by the embodiments of the invention. For example, processor 202 could be a processor made by Intel® Corporation and others. Processor 202 may also comprise a digital signal processor (DSP) and accompanying architecture, such as a DSP from Texas Instruments Incorporated. Processor 202 may further comprise a dedicated processor such as a network processor, embedded processor, micro-controller, controller and so forth.

In one embodiment, memory 210 and disk storage 218 may comprise a machine-readable medium and may include any medium capable of storing instructions adapted to be executed by a processor. Some examples of such media include, but are not limited to, read-only memory (ROM), random-access memory (RAM), programmable ROM, erasable programmable ROM, electronically erasable programmable ROM, dynamic RAM, magnetic disk (e.g., floppy disk and hard drive), optical disk (e.g., CD-ROM) and any other media that may store digital information. In one embodiment, the instructions are stored on the medium in a compressed and/or encrypted format. As used herein, the phrase “adapted to be executed by a processor” is meant to encompass instructions stored in a compressed and/or encrypted format, as well as instructions that have to be compiled or installed by an installer before being executed by the processor. Further, processing system 200 may contain various combinations of machine-readable storage devices through various I/O controllers, which are accessible by processor 202 and which are capable of storing a combination of computer program instructions and data.

Memory 210 is accessible by processor 202 over bus 208 and includes an operating system 216, a program partition 212 and a data partition 214. In one embodiment, operating system 216 may comprise an operating system sold by Microsoft Corporation, such as Microsoft Windows® 95, 98, 2000 and XP, for example. The embodiments are not limited in this context. Program partition 212 stores and allows execution by processor 202 of program instructions that implement the functions of each respective system described herein. Data partition 214 is accessible by processor 202 and stores data used during the execution of program instructions.

In one embodiment, program partition 212 contains program instructions for an SUA module, MG module, PT module and MGSIP module, for example. Although the embodiment has been described in terms of “modules” to facilitate description, one or more circuits, components, registers, processors, software subroutines, or any combination thereof could be substituted for one, several, or all of the modules. Of course, the scope of the embodiments is not limited to this particular set of instructions.

I/O adapter 204 may comprise a network adapter or NIC configured to operate with any suitable technique for controlling communication signals between computer or network devices using a desired set of communications protocols, services and operating procedures, for example. In one embodiment, I/O adapter 204 may operate, for example, in accordance with TCP/IP, Megaco, SIP and SDP, although the embodiments are not limited in this context. I/O adapter 204 also includes appropriate connectors for connecting I/O adapter 204 with a suitable communications medium. I/O adapter 204 may receive communication signals over any suitable medium such as metal leads, semiconductor material, twisted-pair wire, co-axial cable, fiber optic, RF and so forth.

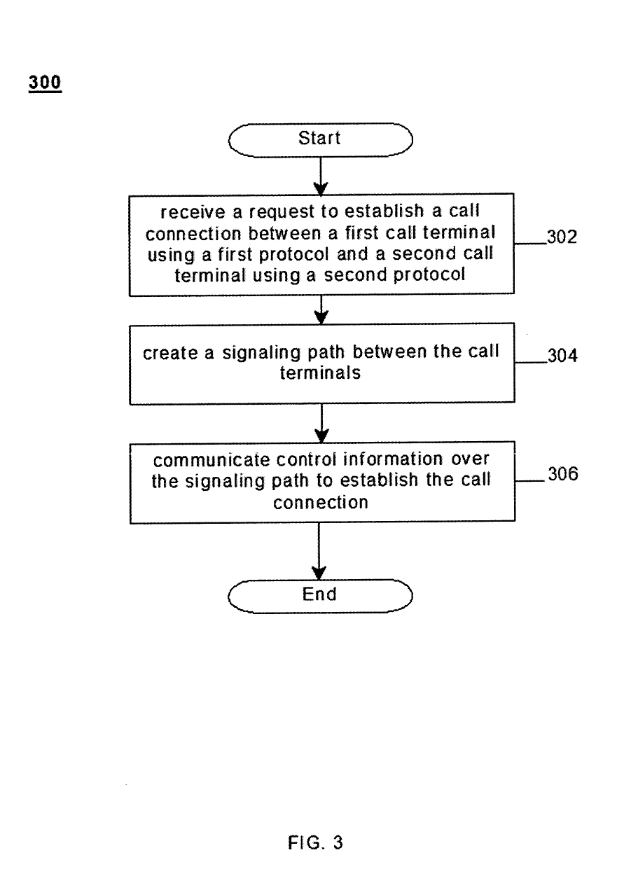

The operations of systems 100 and 200 may be further described with reference to FIG. 3 and accompanying examples. Although FIG. 3 as presented herein may include a particular programming logic, it can be appreciated that the programming logic merely provides an example of how the general functionality described herein can be implemented. Further, the given programming logic does not necessarily have to be executed in the order presented unless otherwise indicated. In addition, although the given programming logic may be described herein as being implemented in the above-referenced modules, it can be appreciated that the programming logic may be implemented anywhere within the system and still fall within the scope of the embodiments.

FIG. 3 illustrates a programming logic 300 for a PT module in accordance with one embodiment. Programming logic 300 may illustrate programming logic to communicate information. Signaling information may be communicated between a SIP network node and a Megaco network node via a signaling network node to establish a multimedia session at block 302. An example of a signaling network node may comprise an IWF node, such as IWF node 108. A media path may be created between the nodes using the signaling information at block 304. Media information between the nodes may be communicated using the media path at block 306. The media information may be communicated using any appropriate media transport protocol, such as RTP, for example.

In one embodiment, the SIP network node may initiate a multimedia session with the Megaco network node using a signaling network node, such as IWF 108. For example, a first set of SIP signaling information may be received from a SIP server, such as SIP server 110. The first set of SIP signaling information may represent the SIP information needed to establish a connection between call terminals. The first set of SIP signaling information may be translated to a first set of Megaco signaling information. The first set of Megaco signaling information may be equivalent to the first set of SIP signaling information in terms of content, but uses the format, syntax and command structure as defined by the Megaco Specification. The first set of Megaco signaling information may be sent to a MGC, such as MGC 102. A second set of Megaco signaling information may be received from MGC 102. The second set of Megaco signaling information may comprise a response to the request to set up a connection. The second set of Megaco signaling information may be translated to a second set of SIP signaling information. The second set of SIP signaling information may be equivalent to the second set of Megaco signaling information, but uses the format, syntax and command structure as defined by the SIP Specification. The second set of SIP signaling information may be sent to the SIP server. This operation may be repeated to convey any amount of signaling information until the media path is established.

In one embodiment, the Megaco network node may initiate a multimedia session with the SIP network node using the signaling network node. For example, a first set of Megaco signaling information may be received from MGC 102. The first set of Megaco signaling information may be translated to a first set of SIP signaling information. The first set of SIP signaling information may be sent to SIP server 110. A second set of SIP signaling information may be received from SIP server 110. The second set of SIP signaling information may be translated to a second set of Megaco signaling information. The second set of Megaco signaling information may be sent to MGC 102. This operation may be repeated to convey any amount of signaling information until the media path is established.

In one embodiment, SIP server 110 may receive a request to initiate the multimedia session from the SIP network node. SIP server 110 may determine whether the request is for a network node outside the SIP Network. If the request is to establish a multimedia session with a network node outside the SIP Network, SIP server 110 may forward the request to the signaling network node for handling.

In one embodiment, MGC 102 may receive a request to initiate the multimedia session from the Megaco network node. MGC 102 may determine whether the request is for a network node outside the Megaco Network. If the request is to establish a multimedia session with a network node outside the Megaco Network, MGC 102 may forward the request to the signaling network node for handling.

In one embodiment, the signaling information may be communicated between a first Megaco network node and a second Megaco network node through at least one SIP network node via at least one signaling network node to establish a multimedia session. A media path may be created between the first and second Megaco network nodes using the signaling information. Media information may then be communicated between the nodes using the media path.

The Megaco network nodes may communicate signaling information using one or more signaling network nodes. For example, a first set of Megaco signaling information from a first MGC at a first signaling network node. The first set of Megaco signaling information may be translated to a first set of SIP signaling information. The first set of SIP signaling information may be sent to a second signaling network node. The first set of SIP signaling information may be translated to a second set of Megaco signaling information. The second set of Megaco signaling information may be sent to a second MGC. A third set of Megaco signaling information may be received at the second signaling network node. The third set of Megaco signaling information may be translated to a second set of SIP signaling information. The second set of SIP signaling information may be sent to the first signaling network node. The second set of SIP signaling information may be translated to a fourth set of Megaco signaling information. The fourth set of Megaco signaling information may be sent to the first MGC. This operation may be repeated for any amount of signaling information until the media path between the two Megaco network nodes is established.

It is worthy to note that the term first, second and third sets of SIP signaling information or Megaco signaling information does not necessarily identify a specific set of signaling information, but rather a sequence of signaling information. Consequently, these terms may apply to a set of operations used for any type of call management operation, such as call setup, call teardown, call transfer, call conferencing, call forwarding, call hold, and so forth.

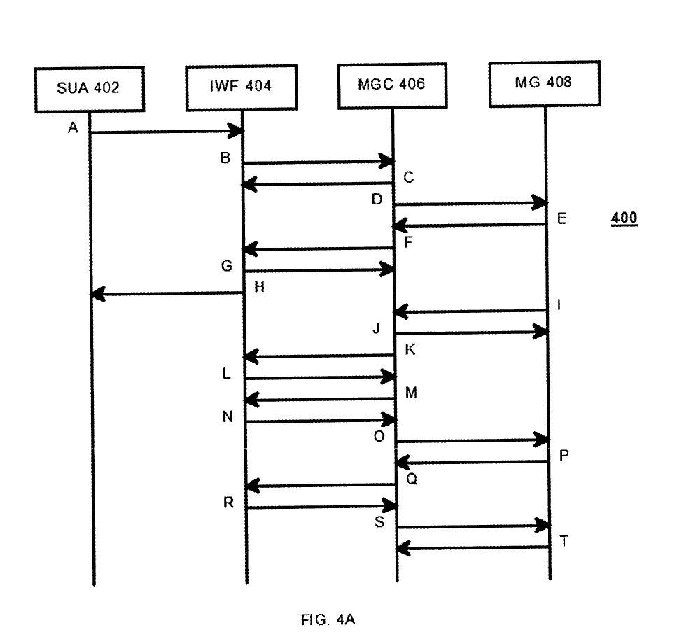

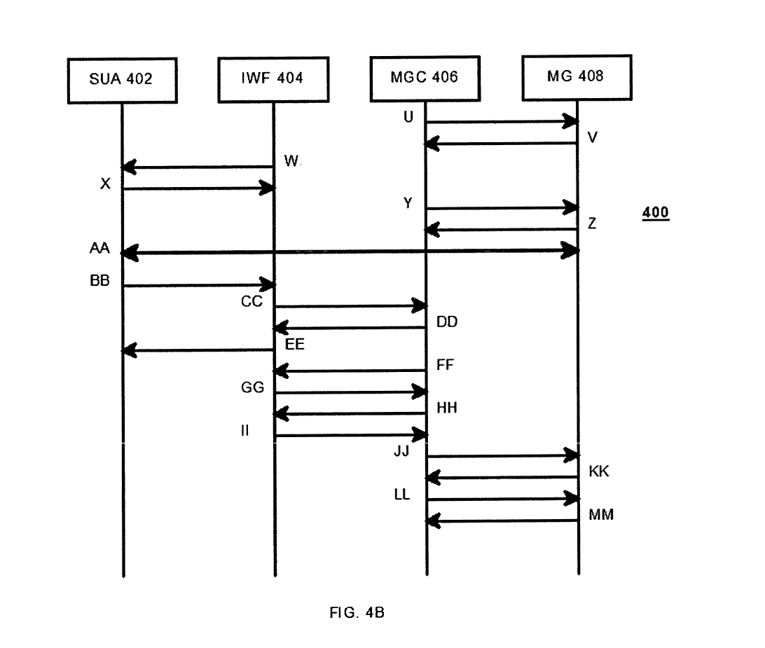

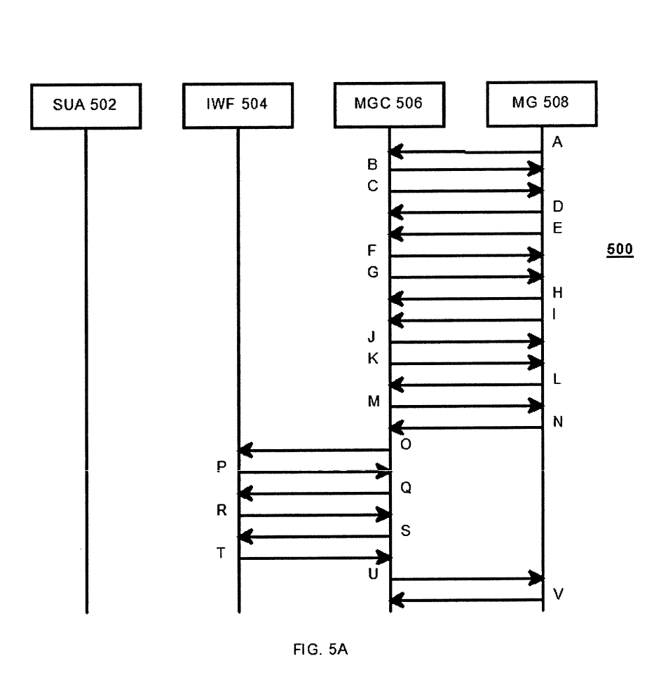

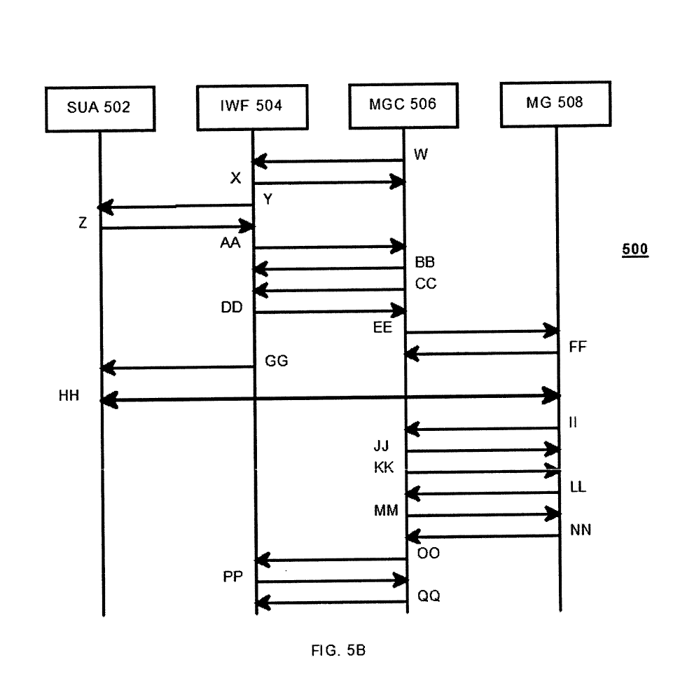

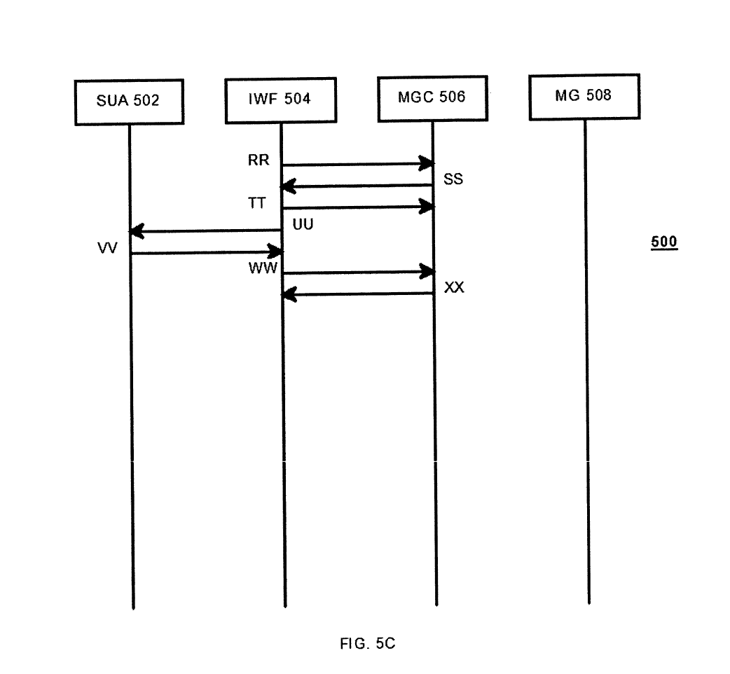

The operation of systems 100 and 200, and the programming logic shown in FIG. 3, may be better understood by way of example. Assume that a caller uses SUA 112 to initiate a telephone call to MG 106. The caller dials the contact information for MG 106 into the keypad of SUA 112. The contact information may comprise, for example, a telephone number, an IP address, a Uniform Resource Locator (URL) a domain name, and email address, and so forth. The embodiments are not limited in this context. The telephone call between SUA 112 and MG 106 may be setup using signaling information translated by IWF 108. The Megaco signaling information from MGC 102 may be communicated using signaling path 114. The SIP signaling information from SIP server 110 may be communicated using signaling path 118. The signaling information may be used to establish media path 120. SUA 112 and MG 106 may communicate media information using RTP, for example. The call management operation may be further illustrated with reference to FIGS. 4A, 4B, and 5A-C.

FIGS. 4A and 4B illustrate a first set of call flow diagrams for one embodiment. FIGS. 4A and 4B illustrate a call flow diagram 400 for the call flow between a SUA 402, an IWF 404, an MGC 406 and an MG 408. In this example, SUA 402 initiates a multimedia session with MG 408. It may be appreciated that the addresses, fields and parameters discussed herein are used by way of example only, and are not limited in this context.

As shown in FIG. 4A, SUA 402 may initiate a multimedia session with MG 408 by sending a SIP message such as an INVITE message to IWF 404. The INVITE message may have a “from” field with “sua@sua.com” and a “to” field with mgl@mg.com at flow A. The INVITE message may also have SDP information embedded in the SIP message, with the SDP information comprising an IP address of “1.2.3.4,” a port number “5678” and a codec “G.711 20 ms,” for example. IWF 404 may receive the INVITE message and translate it to the Megaco equivalent, which in this example is a NOTIFY message, as shown at flow B. IWF 404 may send the NOTIFY message MGC 406 with instructions for the MGSIP module of MGC 406, such as “event=mgsip/inc, parameters ‘from’=sua@sua.com and ‘to’=mgl @mg.com,” for example. MGC 406 may send a NOTIFY message reply to IWF 404 at flow C. MGC 406 may also send a MODIFY message to MG 408, with the information “signal=indx/isx, parameters ‘key’=1001, ‘state’=fast_blink, ‘color’=red” at flow D. MG 408 may send a MODIFY reply to MGC 406 at flow E. MGC 406 may send a MODIFY message to IWF 404 at flow F, with the information “signal=cgx/rt2.” IWF 404 may send a MODIFY reply message to MGC 406 at flow G. IWF 404 also may send a RINGING message to SUA 402 at flow H. The RINGING message indicates to the caller using SUA 402 that the callee using MG 408 is being alerted to an incoming request for a multimedia session.

Once the incoming request is answered, MG 408 may send a NOTIFY message to MGC 406 with the information “observed event=kf/kd, parameters ‘keyID’=1001” at flow I. MGC 406 may send a NOTIFY reply message to MG 408 at flow J. MGC 406 may send an ADD message to IWF 404 at flow K, with the information “context=$.” IWF 404 may send an ADD reply message to MGC 406 at flow L, with the information “context=33.” MGC 406 may send an ADD message to IWF 404 at flow M, with the information “context=33, Local=$.” IWF 404 may send an ADD reply message to MGC 406 at flow N, with the information for an SDP message of “Local={IP=1.2.3.4, port=5678, codec=G.711 20 ms}.” MGC 406 may send an ADD message to MG 408 at flow O, with the information “local SDP=‘v=0. c=IN IP4 $.m=audio $RTP/AVP $. A=ptime:$’.” MG 408 may send an ADD reply message to MGC 406 at flow P, with the information “local SDP=‘v=0. c=IN IP4 192.168.0.99.m=audio 11111 RTP/AVP 0. a=ptime:20.” MGC 406 may send a MODIFY message to IWF 404 at flow Q, with the information “Remote=‘v=0. c=IN IP4 192.168.0.99. m=audio 11111 RTP/AVP 0.’” IWF 404 may send a MODIFY reply message to MGC 406 at flow R. MGC 406 may send a MODIFY message to MG 408 at flow S, with the information “remote SDP”=“v=0. c=IN IP4 1.2.3.4. m=audio 5678 RTP/AVP 0.” MG 408 may send a MODIFY reply message MGC 406 at flow T.

As shown in FIG. 4B, MGC 406 may send a MODIFY message to MG 408 at flow U, with the information “terminationState {yyyaud/gain=0}.” MG 408 may send a MODIFY reply message to MGC 406 at flow V. IWF 404 may send a 200 OK message to SUA 402 at flow W. SUA 402 may send an ACK message to IWF 404 at flow X. MGC 406 may send an ADD message to MG 408 at flow Y. MG 408 may send an ADD reply message to MGC 406 at flow Z.

Once the signaling phase of the multimedia setup operation is completed, a media path may be established between SUA 402 and MG 408 as indicated by flow AA. The users may have a conversation using the media path.

Once the conversation is completed, the multimedia session tear down operation may commence. Assume that SUA 402 hangs up, thereby indicating the end of the multimedia session. SUA 402 may send a BYE message to IWF 404 at flow BB, with the information “‘from’=sua@sua.com, ‘to’=mgl@mg.com.” IWF 404 may send a NOTIFY message to MGC 406 at flow CC, with the information “observed event=yyyco/idle.” MGC 406 may send a NOTIFY reply message IWF 404 at flow DD. IWF 404 may send a 200 OK message to SUA 402 at flow EE. MGC 406 may send a SUBTRACT message to IWF 404 at flow FF. IWF 404 may send a SUBTRACT reply message to MGC 406 at flow GG. MGC 406 may send a SUBTRACT message to IWF 404 at flow HH. IWF 404 may send a SUBTRACT reply message to MGC 406 at flow II. MGC 406 may send a SUBTRACT message to MG 408 at flow JJ. MG 408 may send a SUBTRACT reply message to MGC 406 at flow KK. MGC 406 may send another SUBTRACT message to MG 408 at flow LL. MG 408 may send SUBTRACT reply message to MGC 406 to end the multimedia tear down operation.

FIGS. 5A-C illustrate a second set of call flow diagrams for one embodiment. FIGS. 5A and 5B illustrate a call flow diagram 500 for the call flow between a SUA 502, an IWF 504, an MGC 506 and an MG 508. In this example, MG 508 initiates a multimedia session with SUA 502. It may be appreciated that the addresses, fields and parameters discussed herein are used by way of example only, and are not limited in this context.

Referring to FIG. 5A, assume a user at MG 508 picks up the telephone. MG 508 may send a NOTIFY message to MGC 506 at flow A, with the information “observed event=kf/kd, parameters ‘keyID’=hook.” MGC 506 may send NOTIFY Reply to MG 508 at flow B. MGC 506 may send a MODIFY message to MG 508 at flow C, with the information “signal=cg/dt (dialtone).” MG 508 may send a MODIFY reply message to MGC 506 at flow D. Assume the user of MG 508 dials the number “9.” MG 508 may send a NOTIFY message to MGC 506 at flow E, with the information “observed event=kf/kd, parameters ‘keyID’=9.” MGC 506 may send a NOTIFY reply message to MG 508 at flow F. MGC 506 may send a MODIFY message to MG 508 at flow G, with the information “signal={ }” to stop the dial tone. MG 508 may send a MODIFY reply message to MGC 506 at flow H. Assume at this point that the user of MG 508 dials a SIP URL such as sua@sua.com. MG 508 may send a NOTIFY message to MGC 506 at flow I, with the information “observed event=kf/kd, parameters ‘dialstring’=sua@sua.com. MGC 506 may send a NOTIFY reply message to MG 508 at flow J. MGC 506 may also send an ADD message to MG 508 at flow K. MG 508 may send an ADD reply message to MGC 506 at flow L. MGC 506 may send an ADD message to MG 508 at flow M, with the information “‘Local SDP’=‘v=0. c=IN IP4 $.m=audio $RTP/AVP $. a=ptime:$.’” MG 508 may send an ADD reply message to MGC 506 at flow N, with the information “‘Local SDP’=‘v=0 c=IN IP4 192.168.0.99. m=audio 11111 RTP/AVP 0. a=ptime:20.’”MGC 506 may send a MODIFY message to IWF 504 at flow O, with the information “signal=mgsip/sz, parameters ‘from’=mgl@mg.com, ‘to’=sua@sua.com.” IWF 504 may send a MODIFY reply message to MGC 506 at flow P. MGC 506 may send an ADD message to IWF 504 at flow Q. IWF 504 may send an ADD reply message to MGC 506 at flow R. MGC 506 may send an ADD message to IWF 504 at flow S, with the information “‘Local SDP’=‘v=0. c=IN IP4 $.m=audio $RTP/AVP $. a=ptime:$.”’ IWF 504 may send an ADD reply message to MGC 506 at flow T, with the information “‘Local SDP’=‘v=0. c=IN IP4 0.0.0.0. m=audio 0 RTP/AVP 0. a=ptime:20.”’ MGC 506 may send a MODIFY message to MG 508 at flow U, with the information “‘remote SDP’=‘v=0. c=IN IP4 0.0.0.0. m=audio 0 RTP/AVP 0.”’ MG 508 may send a MODIFY reply message to MGC 506 at flow V.

As shown in FIG. 5B, MGC 506 may send a MODIFY message to IWF 504 at flow W, with the information “‘Remote SDP’=‘v=0. c=IN IP4 192.168.0.99. m=audio 11111 RTP/AVP 0.”’ IWF 504 may send a MODIFY reply message to MGC 506 at flow X. IWF 504 may send an INVITE message to SUA 502 at flow Y. SUA 502 may send a 200 OK message to IWF 504 at flow Z. IWF 504 may send NOTIFY message to MGC 506 at flow AA, with the information “event=mgsip/sch.” MGC 506 may send a NOTIFY reply message to IWF 504 at flow BB. MGC 506 may send an AUDITVALUE message at flow CC, with the information “item=Local.”

It is worthy to note that when MGC 506 sends this ADD message to IWF 504, IWF 504 does not necessarily know any SDP information for SUA 502. In this case, IWF 504 replies with an invalid SDP with IP address 0.0.0.0. This may work because IWF 504 may send exactly the same SDP to MGC 506 when SUA 502 puts MG 508 on hold. MGC 506 may forward this SDP to MG 508 with the information “mode=sendrecv.” If the user of MG 508 starts talking, the RTP packets will be discarded. Eventually, IWF 504 will send the correct SDP to MGC 506, and the user of MG 508 will be able to hear from and talk to the user of SUA 502. The delay should be relatively short. Since the user of MG 508 is the caller, the user should have an experience similar to a normal phone call.

Referring again to FIG. 5B, IWF 504 may send an AUDITVALUE reply message to MGC 506 at flow DD, with the information “Local=‘v=0. c=IN IP4 1.2.3.4. m=audio 5678 RTP/AVP 0. a=ptime:20.”’ MGC 506 may send a MODIFY message to MG 508 at flow EE, with the information “Remote=‘v=0. c=IN IP4 1.2.3.4.m=audio 5678 RTP/AVP 0. a=ptime:20.”’ MG 508 may send a MODIFY reply message to MGC 506 at flow FF. IWF 504 may send an ACK message to SUA 502 at flow GG.

At this point, the signaling phase to set up the multimedia session should be completed, and the media path may be established as indicated by flow HH. The users of MG 508 and SUA 502 may begin their conversation using the media path. After some period of time, the conversation will end and the multimedia tear down operation may begin.

Assume in this example that MG 508 intends to terminate the multimedia session, and hangs up the telephone. MG 508 may send a NOTIFY message to MGC 506 at flow II, with the information “event=onhook.” MGC 506 may send a NOTIFY reply message to MG 508 at flow JJ. MGC 506 may send a SUBTRACT message to MG 508 at flow KK. MG 508 may send a SUBTRACT reply message to MGC 506 at flow LL. MGC 506 may send another SUBTRACT message to MG 508 at flow MM. MG 508 may send a SUBTRACT reply message to MGC 506 at flow NN. MGC 506 may then send a SUBTRACT message to IWF 504 at flow OO. IWF 504 may send a SUBTRACT reply message to MGC 506 at flow PP. MGC 506 may send another SUBTRACT message to IWF 504 at flow QQ.

As shown in FIG. 5C, IWF 504 may send a SUBTRACT reply message to MGC 506 at flow RR. MGC 506 may send a MODIFY message to IWF 504 at flow SS, with the information “signal=yyyco/rel.” IWF 504 may send a MODIFY reply message to MGC 506 at flow TT. IWF 504 may send a BYE message to SUA 502 at flow UU. SUA 502 may send a 200 OK message in response to the BYE message to IWF 504 at flow VV. IWF 504 may send a NOTIFY message to MGC 506 at flow WW, with the information “observed event=yyyco/idle.” MGC 506 may send a NOTIFY reply message to IWF 504 at flow XX, to terminate the tear down operation for the multimedia session.

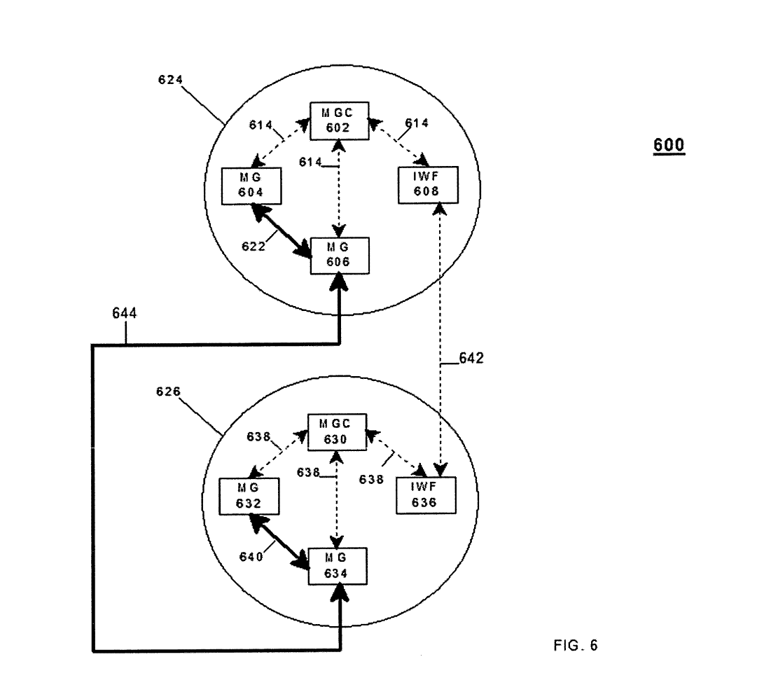

FIG. 6 illustrates a second system suitable for practicing one embodiment. FIG. 6 may illustrate a system 600. In one embodiment, system 600 may comprise a packet-based multimedia communication system similar to system 100 as described with reference to FIG. 1. VOP system 600 may communicate Internet multimedia conferences and telephone calls, for example.

In one embodiment, system 600 may comprise a pair of Megaco networks 624 and 644. Megaco networks 624 and 644 are similar in structure and function as Megaco network 124. For example, elements 602, 604, 606, 608, 614 and 622 of Megaco network 624 are similar to elements 102, 104, 106, 108, 116 and 122, respectively, of Megaco network 124. Further, elements 630, 632, 634, 636, 638 and 640 of Megaco network 626 are similar to elements 102, 104, 106, 108, 116 and 122, respectively, of Megaco network 124. In addition, network 624 and 626 may communicate signaling information via signaling path 642, and media information via media path 644. Although a limited number of network nodes and paths are shown in FIG. 6 for purposes of clarity, it can be appreciated that any number of network nodes and paths may be added to system 600 and still fall within the scope of the embodiments.

In addition to allowing communications between a Megaco network and a SIP network, an IWF node may also facilitate communications between different Megaco networks using SIP. For example, assume a call terminal MG 606 of network 624 wants to initiation a multimedia call session with MG 634 of network 626. MG 606 may initiate signaling messages to MGC 602. MGC 602 may route the signaling messages to IWF 608. IWF 608 may translate the Megaco signaling information using its PT module into SIP signaling information, and communicate the SIP signaling information using its SUA module over a SIP network. IWF 636 of network 626 may receive the SIP signaling information via its SUA module, and use its PT module to translate the SIP signaling information back to Megaco signaling information. This may continue until signaling path 642 is established. Once the signaling path is established between the two Megaco networks, address information may be communicated between the two networks to establish media path 644. Once media path 644 is established, MG 606 and MY 634 may begin communicating media information. Other call management functions, such as call setup, call teardown, call transfer, call conferencing, call forwarding, call hold, and so forth, may be implemented in a similar manner.

As discussed previously, the MGC and IWF nodes may use a thin client software package referred to as MGSIP module. The MGSIP module may communicate certain SIP-related information between the MGC and IWF. An example of SIP-related information may comprise SIP Uniform Resource Locators.

In one embodiment, the MGSIP module may define the properties, events and signals needed to translate information between SIP and Megaco networks. The MGSIP module may extend the functionality provided by the Megaco Specification. Some examples are given in Tables 1-3 below. The embodiments, however, are not limited in this context.

In one embodiment, the MGSIP module may define certain properties for the translation. An example of these properties may be summarized in Table 1 below.

TABLE 1

| PROPERTY IDENTIFIER | DESCRIPTION |
|---|---|
| DatabaseChange (0x01) | MGC informs IWF about the change in |
| | the database. |
| | The IWF reads the database information |
| | again. |
| | IWF registers the new SIP-URL with the |
| | SIP Registrar. |
| AlarmControl (0x02) | MGC instructs IWF to enable or disable |
| | alarms |
| | If alarms are enabled, the IWF displays |
| | alarms at the console |
| | If alarms are disabled, the IWF stops |
| | display of alarms at the console. |
| DebugControl (0x03) | MGC instructs IWF to enable or disable |
| | debug printing |
| | If debug prints are enabled, the IWF |
| | displays debug prints at the console |
| | If debug prints are disabled, the IWF |
| | stops the display of debug prints at the |
| | console. |
| TraceControl (0x02) | MGC instructs IWF to enable or disable |
| | network PDU trace. |
| | If trace is enabled, the IWF displays the |
| | PDU trace at the console. |
| | If trace is disabled, the IWF stops the |
| | display of the PDU trace at the console |

In one embodiment, the MGSIP module may define certain events for the translation. An example of these events may be summarized in Table 2 below.

TABLE 2

| EVENT IDENTIFIER | DESCRIPTION |
|---|---|
| inc (0x01) | This event is requested by the MGC to |
| | detect incoming calls. |
| | This event is reported by the IWF when a |
| | remote SIP user sends an INVITE |
| | request to the IWF. |
| | The from parameter value is the SIP URL |
| | of the remote SIP user. |
| | The to parameter value is the SIP URL of |
| | the local MG phone. |
| | MGC uses the reported event to send |
| | ADD commands to the local MG phone |
| | and to the IWF. |
| cpg (0x03) | This event is requested by the MGC to |
| | track the progress of an outgoing call. |
| | This event is reported by the IWF for any |
| | 1xx SIP responses received from the |
| | remote SIP user. |
| | MGC may use the reported event to take |
| | certain action based on the response |
| | code, such as: |
| | Giving ringback signal to local MG phone |
| | when code = 180 |
| | Giving call progress signal to the local |
| | MG phone when code = 183. |
| sch (0x04) | This event is requested by the MGC to |
| | reveal when the remote SIP user has |
| | changed session parameters, such as SDP |
| | information. |
| | This event is reported by the IWF when |
| | the remote SIP user changes the session |
| | parameters, particularly when: |
| | Remote user puts local MG phone on |
| | hold by sending a re-INVITE with an |
| | invalid SDP |
| | Remote user takes local MG phone off |
| | hold by sending a re-INVITE with a |
| | new valid SDP |
| | MGC uses the reported event as follows: |
| | AuditValue of LocalDescriptor SDP at |
| | the IWF's RTP termination |
| | Modify RemoteDescriptor SDP of the |
| | local MG phone's RTP termination |
| | using the value that MGC obtained from |
| | IWF. |
| xfer (0x05) | MGC requests this event to see whether |
| | the remote SIP user is trying to transfer |
| | the local MG phone to another SIP user. |
| | IWF reports this event when the remote |
| | SIP user sends a BYE with Also: |
| | header. The new SIP user is identified in |
| | the To URL. |
| | MGC uses the reported event as follows: |
| | MGC sends SUBTRACT commands to |
| | the IWF to release the original call. |
| | This behavior is the same as if IWF had |
| | reported a yyyco/idle event. |
| | MGC sends ADD commands to the IWF |
| | to bring the new SIP user into the |
| | call. |
| | After IWF succeeds, MGC sends |
| | MODIFY to the local MG phone to let it |
| | know the new user's SIP URL and SDP |
| | information. |

In one embodiment, the MGSIP module may define certain signals for the translation. An example of these signals may be summarized in Table 3 below.

TABLE 3

| SIGNAL IDENTIFIER | DESCRIPTION |
|---|---|
| sz (0x01) | The MGC sends this signal to the IWF in |
| | an ADD command, to initiate an |
| | outgoing call. |
| | The IWF sends an INVITE when the |
| | signal comes. |
| | to parameter value is the SIP URL of the |
| | remote SIP user. |
| | from parameter value is the SIP URL of |
| | the local MG phone. |
| rs (0x02) | The MGC sends this signal to the IWF in |
| | a MODIFY command, to reserve a |
| | termination in IWF for a future outgoing |
| | call. MGC may later “unreserve” the |
| | termination through an yyyco/rel signal. |
| | The IWF marks the termination as |
| | reserved and does not allow incoming calls |
| | on that termination ID. |
| xfer (0x05) | The MGC sends this signal to the IWF in |
| | a MODIFY command, to transfer the |
| | remote SIP user from local MG phone |
| | MG1 to local MG phone MG2. |
| | to parameter value is the SIP URL of |
| | MG2. |
| | IWF uses the signal to send a BYE with |
| | Also: to the remote SIP user. After the |
| | BYE succeeds, and if MGC has requested |
| | the yyyco/idle event, IWF sends a |
| | yyyco/idle to the MGC. |

While certain features of the embodiments of the invention have been illustrated as described herein, many modifications, substitutions, changes and equivalents will now occur to those skilled in the art. It is, therefore, to be understood that the appended claims are intended to cover all such modifications and changes as fall within the true spirit of the embodiments of the invention.

1. A method to communicate information, comprising:
communicating signaling information between a Session Initiation Protocol network node and a Megaco network node via a signaling network node for a multimedia session;
creating a media path between said nodes using said signaling information; and
communicating media information between said nodes using said media path.

2. The method of claim 1, wherein said communicating said signaling information comprises:
a) receiving a first set of Session Initiation Protocol signaling information from a Session Initiation Protocol server;
b) translating said first set of Session Initiation Protocol signaling information to a first set of Megaco signaling information;
c) sending said first set of Megaco signaling information to a media gateway controller;
d) receiving a second set of Megaco signaling information from said media gateway controller;
e) translating said second set of Megaco signaling information to a second set of Session Initiation Protocol signaling information;
f) sending said second set of Session Initiation Protocol signaling information to said Session Initiation Protocol server; and
g) repeating a)-f) until said media path is established.

3. The method of claim 1, wherein said communicating said signaling information comprises:
a) receiving a first set of Megaco signaling information from a media gateway controller;
b) translating said first set of Megaco signaling information to a first set of Session Initiation Protocol signaling information;
c) sending said first set of Session Initiation Protocol signaling information to a Session Initiation Protocol server;
d) receiving a second set of Session Initiation Protocol signaling information from said Session Initiation Protocol server;
e) translating said second set of Session Initiation Protocol signaling information to a second set of Megaco signaling information;
f) sending said second set of Megaco signaling information to said media gateway controller; and
g) repeating a)-f) until said media path is established.

4. The method of claim 1, wherein said communicating said signaling information comprises:
receiving a request at a Session Initiation Protocol server to establish said multimedia session between said Session Initiation Protocol network node and said Megaco network node;
determining whether said request is handled by said signaling network node; and
sending said signaling information to said signaling network node.

5. The method of claim 1, wherein said communicating said signaling information comprises:
receiving a request at a media gateway controller to establish said multimedia session between said Session Initiation Protocol network node and said Megaco network node;
determining whether said request is handled by said signaling network node; and
sending said signaling information to said signaling network node.

6. The method of claim 1, wherein said communicating media information comprises communicating media information using a real time protocol.

7. A method to communicate information, comprising:
communicating signaling information between a first Megaco network node and a second Megaco network node through at least one Session Initiation Protocol network node via at least one signaling network node to establish a multimedia session;
creating a media path between said first and second Megaco network nodes using said signaling information; and
communicating media information between said nodes using said media path.

8. The method of claim 7, wherein said communicating said signaling information comprises:
a) receiving a first set of Megaco signaling information from a first media gateway controller at a first signaling network node;
b) translating said first set of Megaco signaling information to a first set of Session Initiation Protocol signaling information;
c) sending said first set of Session Initiation Protocol signaling information to a second signaling network node;
d) translating said first set of Session Initiation Protocol signaling information to a second set of Megaco signaling information;
e) sending said second set of Megaco signaling information to a second media gateway controller;
f) receiving a third set of Megaco signaling information at said second signaling network node;
g) translating said third set of Megaco signaling information to a second set of Session Initiation Protocol signaling information;
h) sending said second set of Session Initiation Protocol signaling information to said first signaling network node;
i) translating said second set of Session Initiation Protocol signaling information to a fourth set of Megaco signaling information;
j) sending said fourth set of Megaco signaling information to said first media gateway server; and
k) repeating a)-j) until said media path is established.

9. The method of claim 7, wherein said communicating said signaling information comprises:
receiving a request at a media gateway controller to establish said multimedia session between said first Megaco network node and said second Megaco network node;
determining whether said request is handled by said signaling network node; and
sending said signaling information to said signaling network node.

10. The method of claim 7, wherein said communicating media information comprises communicating media information using a real time protocol.

11. A system to communicate information, comprising:
a Megaco network node to communicate Megaco signaling information;
a Session Initiation Protocol network node to communicate session initiation signaling information;
an interworking node connected to said Megaco network node and said Session Initiation Protocol network node to translate said Megaco signaling information to Session Initiation Protocol signaling information, and vice-versa; and
an antenna to communicate said signaling information.

12. The system of claim 11, wherein said interworking node comprises:
a Session Initiation Protocol module to appear as a Session Initiation Protocol network node and receive said Session Initiation Protocol signaling information;
a media gateway module to appear as a media gateway and receive said Megaco signaling information; and
an interworking module to translate said signaling information.

13. The system of claim 11, further comprising:
a media gateway controller;
a Session Initiation Protocol server; and
a transceiver to communicate said translated Megaco signaling information to said media gateway controller, and said translated Session Initiation Protocol signaling information to said Session Initiation Protocol server.

14. An apparatus to communicate information, comprising:
a Session Initiation Protocol module to appear as a Session Initiation Protocol network node and receive Session Initiation Protocol signaling information;
a media gateway module to appear as a media gateway and receive Megaco signaling information; and
an interworking module to translate said signaling information.

15. The apparatus of claim 14, further comprising an media gateway Session Initiation Protocol module.

16. The apparatus of claim 14, further comprising:
a media gateway controller;
a Session Initiation Protocol server; and
a transceiver to communicate said translated Megaco signaling information to said media gateway controller, and said translated Session Initiation Protocol signaling information to said Session Initiation Protocol server.

17. An article comprising:
a storage medium;
said storage medium including stored instructions that, when executed by a processor, result in communicating information by communicating signaling information between a Session Initiation Protocol network node and a Megaco network node via a signaling network node for a multimedia session, creating a media path between said nodes using said signaling information, and communicating media information between said nodes using said media path.

18. The article of claim 17, wherein the stored instructions, when executed by a processor, further result in communicating said signaling information by a) receiving a first set of Session Initiation Protocol signaling information from a Session Initiation Protocol server, b) translating said first set of Session Initiation Protocol signaling information to a first set of Megaco signaling information, c) sending said first set of Megaco signaling information to a media gateway controller, d) receiving a second set of Megaco signaling information from said media gateway controller, e) translating said second set of Megaco signaling information to a second set of Session Initiation Protocol signaling information, f) sending said second set of Session Initiation Protocol signaling information to said Session Initiation Protocol server, and g) repeating a)-f) until said media path is established.

19. The article of claim 17, wherein the stored instructions, when executed by a processor, further result in communicating said signaling information by a) receiving a first set of Megaco signaling information from a media gateway controller, b) translating said first set of Megaco signaling information to a first set of Session Initiation Protocol signaling information, c) sending said first set of Session Initiation Protocol signaling information to a Session Initiation Protocol server, d) receiving a second set of Session Initiation Protocol signaling information from said Session Initiation Protocol server; e) translating said second set of Session Initiation Protocol signaling information to a second set of Megaco signaling information, f) sending said second set of Megaco signaling information to said media gateway controller, and g) repeating a)-f) until said media path is established.

20. The article of claim 17, wherein the stored instructions, when executed by a processor, further result in communicating said signaling information by receiving a request at a Session Initiation Protocol server to establish said multimedia session between said Session Initiation Protocol network node and said Megaco network node, determining whether said request is handled by said signaling network node, and sending said signaling information to said signaling network node.

21. The article of claim 17, wherein the stored instructions, when executed by a processor, further result in communicating said signaling information by receiving a request at a media gateway controller for said multimedia session between said Session Initiation Protocol network node and said Megaco network node, determining whether said request is handled by said signaling network node, and sending said signaling information to said signaling network node.

22. The article of claim 17, wherein the stored instructions, when executed by a processor, further result in communicating media information using a real time protocol.
